(19) United States
(12) Patent Application Publication
(10) Pub. No.: US 2012/0103199 A1
(43) Pub. Date: May 3, 2012

(54) ARTIFICIAL SHELL FOR COOKING

(76) Inventors: Elizabeth Ravreby KAUFMAN, Houston, TX (US); Jeff BROWNING, Charlotte, NC (US); Todd STANCOMBE, Charlotte, NC (US)

(21) Appl. No.: 13/286,696

(22) Filed: Nov. 1, 2011

Related U.S. Application Data
(60) Provisional application No. 61/408,815, filed on Nov. 1, 2010.

(51) Int. Cl. A47J 29/00; B65D 8/04

(52) U.S. Cl. 99/426; 220/4.21

(57) ABSTRACT

An artificial shell for cooking includes, a top portion, having a fill opening therethrough, a bottom portion, and a fill opening cover. The top portion is removably attachable to the bottom portion and the top portion and bottom portion together define an inner storage chamber. Furthermore, the fill opening cover completely covers the fill opening.

### CROSS-REFERENCE TO RELATED APPLICATION

The present application is a U.S. nonprovisional patent application of, and claims priority under 35 U.S.C. §119(e) to, U.S. provisional patent application Ser. No. 61/408,815, filed Nov. 1, 2010, which provisional patent application is incorporated by reference herein. The present application also incorporates herein by reference U.S. Design patent application Ser. No. 29/369,535, filed Sep. 9, 2010.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to cooking devices. More particularly, the present invention relates to devices used to cook eggs with or without additional ingredients. The present invention also relates to methods of preparing hardboiled eggs. In particular, it takes considerable time and effort to de-shell hardboiled eggs

A need exists for improvement in this field. This, and other needs, are addressed by one or more aspects of the present invention.

### SUMMARY OF THE INVENTION

The present invention includes many aspects and features. Moreover, while many aspects and features relate to, and are described in, the context of an artificial shell for cooking, the present invention is not limited to use only in food preparation, as will become apparent from the following summaries and detailed descriptions of aspects, features, and one or more embodiments of the present invention.

Accordingly, broadly defined, one aspect of the present invention relates to an artificial shell for cooking, as substantially shown and described.

Another aspect of the present invention, broadly defined, relates to an artificial shell. An exemplary such artificial shell includes a top portion and a bottom portion. Furthermore, the top portion and bottom portion are removably secured together to define an inner chamber for storing solid and liquid ingredients.

In a feature of this aspect of the invention, the artificial shell further includes a fill opening. In a variation of this feature, the artificial shell further includes a fill opening cover. In still another variation, the fill opening cover includes a grip portion.

Another feature of the present invention includes a threaded screw adapted to removably secure the top portion to the bottom portion.

In another feature of this aspect of the invention, the artificial shell includes a base.

In yet another feature, the artificial shell is generally egg-shaped.

In still another feature, the artificial shell is comprised of food grade polypropylene plastic.

In a further feature of this aspect of the invention, the artificial shell is comprised of microwave safe material.

In yet another feature, the artificial shell is comprised of stainless steel.

In still another feature, the inner chamber has a volume of approximately seventy milliliters.

In a further feature, the inner chamber has a volume of approximately ninety milliliters.

In yet another feature, the inner chamber has a volume of approximately one hundred twenty milliliters.

In still another feature, the inner chamber has a volume of approximately one hundred eighty milliliters.

Another aspect of the present invention, broadly defined, relates to a cooking system as substantially shown and described.

Another aspect of the present invention, broadly defined, relates to a cooking system. An exemplary such cooking system includes an artificial shell and food ingredients. Furthermore, the artificial shell is adapted to house the food ingredients.

In a feature of this aspect of the present invention, the food ingredients include one or more eggs.

In another feature, the food ingredients include fruit.

In yet another feature, the food ingredients include spices.

In still another feature, the food ingredients include artificial flavoring.

In a further feature still, the food ingredients include meat.

In yet a further feature, the food ingredients include poultry.

In another feature, the food ingredients include fish.

In yet another feature, the food ingredients are placed within the artificial through a fill opening.

In still another feature, after cooking, the food ingredients have the same shape as the artificial shell.

Another aspect of the present invention, broadly defined, is a method of preparing food, as substantially shown and described.

Another aspect of the present invention, broadly defined, is a method of preparing an egg, as substantially shown and described.

Another aspect of the present invention, broadly defined, is a method of hard boiling an egg, as substantially shown and described.

Another aspect of the present invention, broadly defined, is a method of cooking an egg. An exemplary such method includes the steps of: cracking an egg; placing at least a portion of the egg in an artificial shell; cooking the portion of the egg within the artificial shell; and removing the egg from the artificial shell.

Another aspect of the present invention, broadly defined, is a method of cooking an egg in an artificial shell. An exemplary such method includes the step of providing an artificial shell having a top portion with a fill opening therethrough, a bottom portion, and a fill opening cover. Further, the top portion is removably attachable to the bottom portion, the top portion and bottom portion together define an inner storage chamber, and the fill opening cover completely covers the fill opening. An exemplary such method further includes the steps of removing the fill opening cover to expose the fill opening; cracking an egg; depositing at least a portion of the egg's contents into the inner storage chamber via the fill opening; attaching the fill opening cover to completely seal the fill opening; placing the artificial shell into a boiling water; allowing the portion of the egg's contents within the artificial shell to cook; removing the artificial shell from boiling water; detaching the top portion from the bottom portion; and removing the cooked portion of the egg's contents from the artificial shell.

In a feature of this aspect of the invention, a threaded screw is used to removably attach the top portion to the bottom portion.

In another feature, the method includes the step of depositing one or more spices into the inner storage chamber via the fill opening.

In yet another feature, the method includes depositing vegetables into the inner storage chamber via the fill opening.

In yet another feature, the method includes depositing fruit into the inner storage chamber via the fill opening.

In still another feature, the method includes depositing meat into the inner storage chamber via the fill opening.

In another feature still, the method includes depositing poultry into the inner storage chamber via the fill opening.

In yet a further feature, the method includes depositing fish into the inner storage chamber via the fill opening.

In still another feature, the method includes depositing artificial flavoring into the inner storage chamber via the fill opening.

In still a further feature, the method includes depositing one or more liquid substances into the inner storage chamber via the fill opening.

In still another feature, the method includes shaking the artificial shell.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 is a front view of an artificial shell for cooking in accordance with one or more aspects of the present invention, in a fully assembled configuration;

FIG. 2 is an exploded front view of the artificial shell 10 of FIG. 1;

FIG. 3 is a right side view of the artificial shell 10 of FIG. 1;

FIG. 4A is a top view of the artificial shell 10 of FIG. 1;

FIG. 4B is a top view of the artificial shell 10 of FIG. 1, with the fill opening cover removed;

FIG. 5 is bottom view of the artificial shell 10 of FIG. 1; and

FIG. 6 is a cross sectional view of the artificial shell of FIG. 1, taken along line 6-6.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

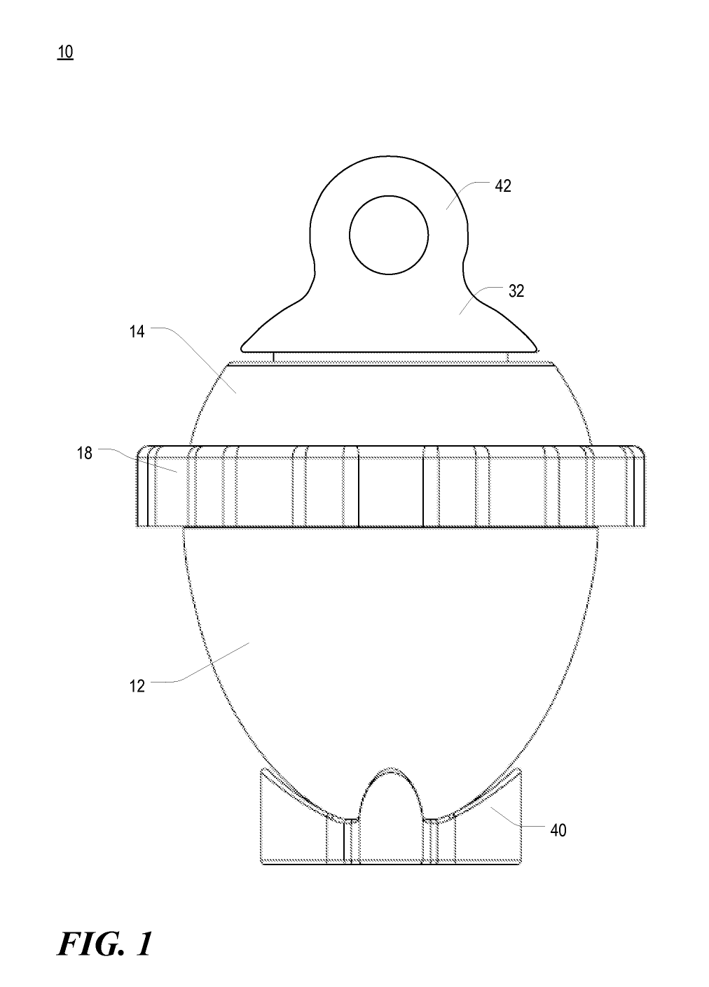

FIG. 1 is a front view of an artificial shell for cooking 10 in accordance with one or more aspects of the present invention, in a fully assembled configuration. In at least one preferred embodiment, the artificial shell 10 is egg-shaped and comprised of a food grade polypropylene plastic. However, it will be appreciated by one with ordinary skill in the art that an artificial shell for cooking 10 need not be limited in shape to that of an egg, but, rather, may be of any shape appropriate for cooking, including, but not limited to, a sphere, a cylinder, a rectangular prism, a pyramid, a cube, and a torus. Furthermore, it will be appreciated that an artificial shell may be comprised of any variety of food-safe, non-toxic materials. For instance, in at least one contemplated embodiment, an artificial shell is comprised of stainless steel. In one or more contemplated embodiments, an artificial shell for cooking is comprised of microwave-safe materials.

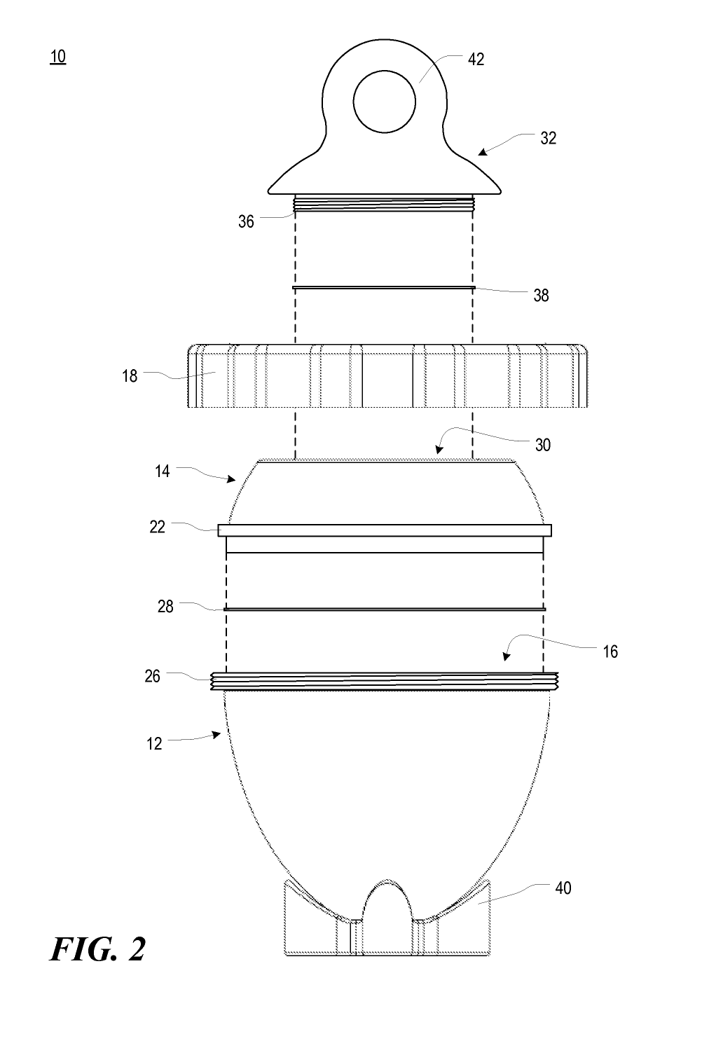

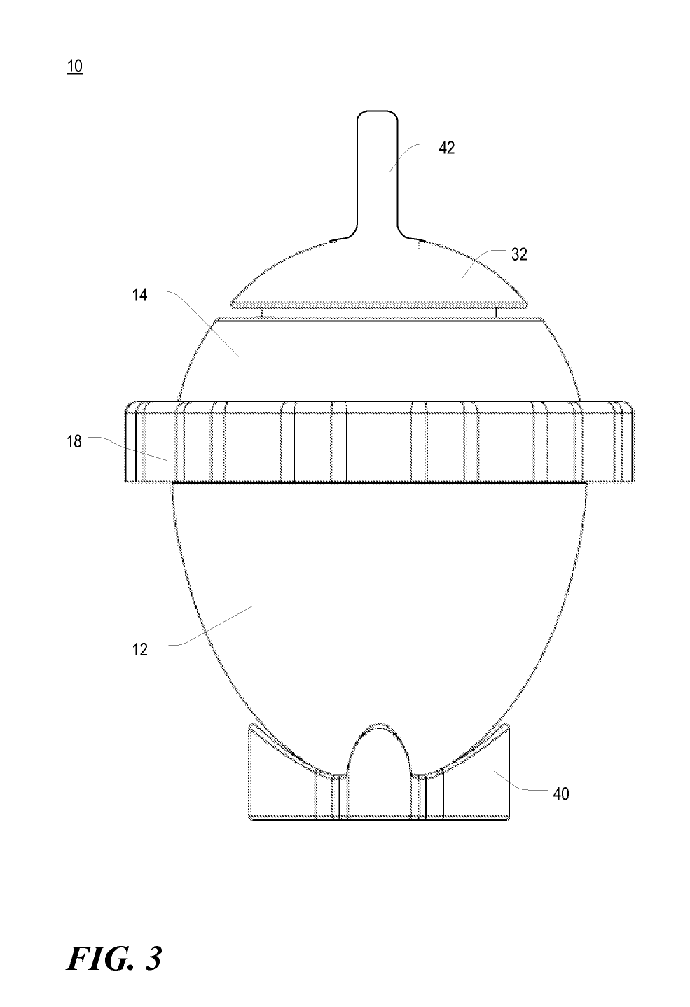

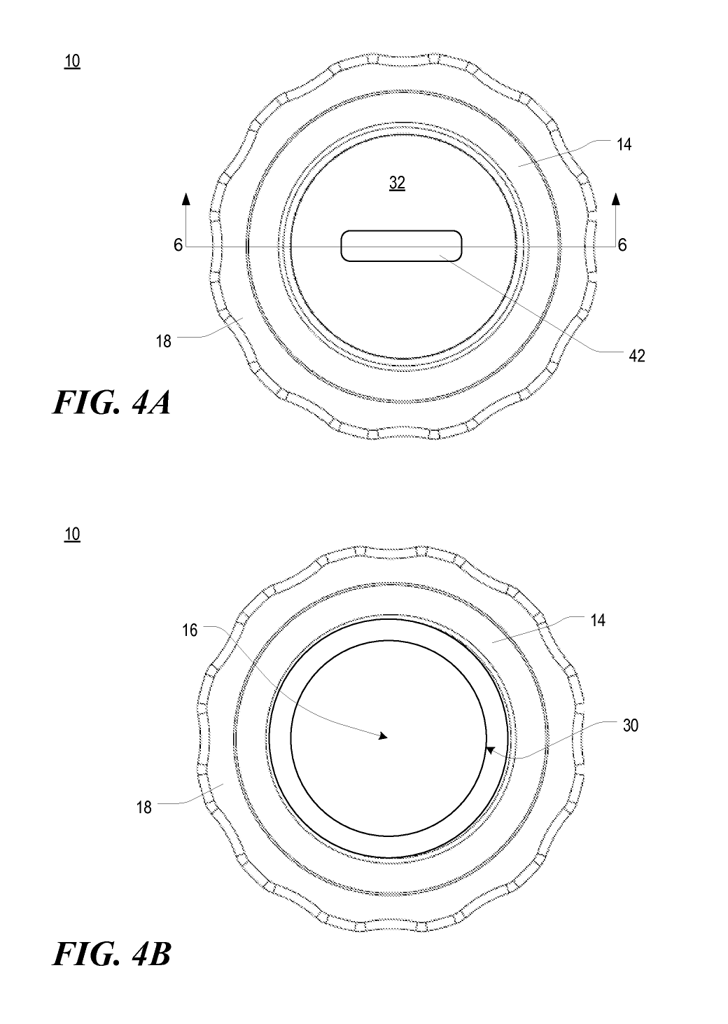

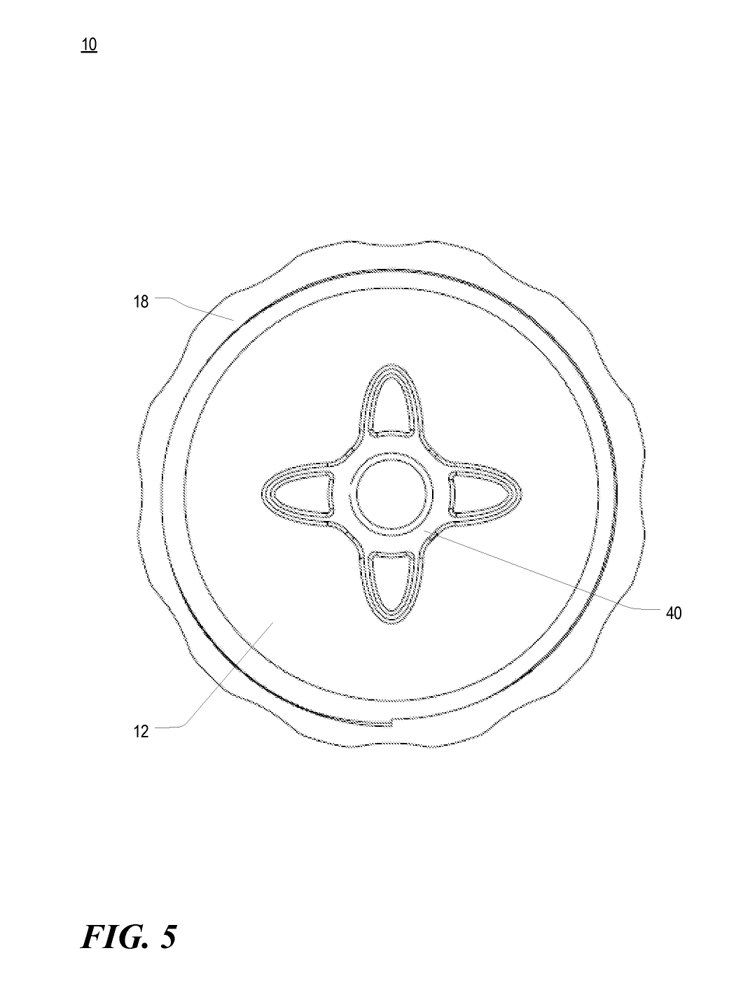

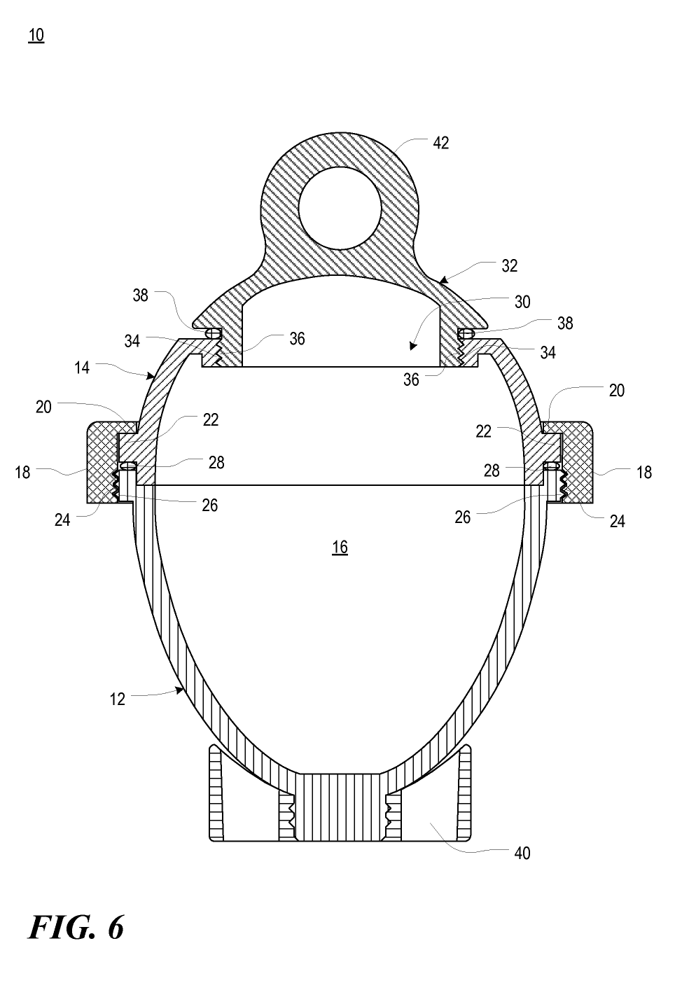

FIG. 2 is an exploded front view of the artificial shell 10 of FIG. 1. FIG. 3 is a right side view of the artificial shell 10 of FIG. 1. FIG. 4A is a top view of the artificial shell 10 of FIG. 1. FIG. 4B is a top view of the artificial shell 10 of FIG. 1, with the fill opening cover removed. FIG. 5 is bottom view of the artificial shell 10 of FIG. 1. FIG. 6 is a cross sectional view of the artificial shell 10 of FIG. 1, taken along line 6-6 (as seen in FIG. 4A).

As best shown in FIG. 2, the artificial shell for cooking 10 is of multi-piece construction. The artificial shell 10 comprises a bottom portion 12 and a top portion 14 removably secured together to define a hollow, inner storage chamber 16 for holding solid and/or liquid ingredients. In at least one preferred embodiment, the inner storage chamber 16 has a capacity of seventy milliliters (70-mL). In other contemplated embodiments, the inner storage chamber has an alternate capacity. For instance in at least one preferred embodiment, the inner storage chamber has a capacity of ninety milliliters (90-mL). In another embodiment, the capacity is one hundred twenty milliliters (120-mL). In yet another embodiment, the capacity is one hundred eighty milliliters (180-mL). The bottom portion 12 and the top portion 14 are removably secured using a threaded screw 18. As best illustrated in the cross-sectional view of FIG. 6, the threaded screw 18 includes a lip 20 configured to rest against a ledge 22 situated near the bottom of the top portion 14. The threaded screw 18 further includes an interior thread 24 configured to mate with an exterior thread 26 situated near the top of the bottom portion 12. As the threaded screw 18 is rotatably secured to the bottom portion 12, the lip 20 exerts force on the ledge 22, compressing the top portion 14 and the bottom portion 12. In one or more preferred embodiments, the artificial shell 10 further comprises a first seal 28 at the junction of the bottom portion 12 and the top portion 14. This first seal 28 is water tight to prevent the leakage of any liquid housed within the inner storage chamber 16.

The artificial shell 10 further comprises a fill opening 30 in the top portion 14 and a fill opening cover 32. It will be appreciated that the fill opening 30 can located at alternative positions on the artificial shell 10. In at least one preferred embodiment, best shown in the cross-sectional view of FIG. 6, the fill opening 30 includes a threaded inner surface 34, and a bottom portion of the fill opening cover 32 includes a threaded outer surface 36 configured to threadably mate with the threaded inner surface 34 of the fill opening 30. In one or more preferred embodiments, the artificial shell 10 further includes a second seal 38 around the fill opening cover 32 that provides a water tight seal at the junction of the fill opening 30 and the fill opening cover 32 to prevent the leakage of any liquid housed within the inner storage chamber 16. The fill opening cover 32 may also include a grip 42 located at a top portion thereof.

The artificial shell 10 further includes a base 40. The base 40 may be either permanently or removably affixed to the artificial shell 10 near the bottom of the bottom portion 12. The base 40 permits the artificial shell 10 to remain free-standing and stationary on any flat surface. In one or more preferred embodiments, as seen in FIG. 6, the base has a threaded opening and may be threadably affixed to the bottom portion 12.

Operation of the artificial shell for cooking 10 can now be understood. Initially, the artificial shell 10 is in a fully assembly configuration, as seen in FIG. 1. To begin using the artificial shell, a user removes the fill opening cover 32 by rotating the grip 42 in a counter-clockwise manner, removing the cover 32 and exposing the fill opening 30, as seen in FIG. 4B. Next, a user cracks a raw egg and deposits either some or all of the contents of the egg in to the inner storage chamber 16 of the artificial shell 10 through the fill opening 30. The user may add additional ingredients to the inner storage chamber 16 including, but not limited to, spices, artificial flavorings, vegetables, fruits, starches, meat, poultry, and fish. The fill opening cover 32 is then threadably re-attached to the top portion 14 to cover the fill opening 30, sealing the contents of the artificial shell 10 therein. Once the contents have been secured, the artificial shell 10 may be shaken to mix the ingredients housed therein. Next, the user cooks the egg in the artificial shell 10 by submerging the artificial shell 10 in boiling water. It will be appreciated that the user can cook the contents of the artificial shell 10 using any acceptable method. For instance, with certain embodiments of the artificial shell, the user may place the artificial shell 10 into a microwave oven. Other embodiments allow the contents to be baked, broiled, fried or grilled. Once the egg within the artificial shell 10 has been cooked for the desired length of time, the artificial shell 10 is removed from the boiling water and the threaded screw 18 is rotatably removed, disconnecting the bottom portion 12 from the top portion 14. The user can pull the two portions 12,14 apart and remove the cooked egg located in the inner storage chamber 16.

The artificial shell 10 is capable of preparing a wide variety of meals, including, but not limited to, hard boiled eggs, deviled eggs, egg salad, chopped egg with smoked salmon, soft boiled eggs, eggs Benedict, chef's salad, and omelets.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1.-36. (canceled)

37. An artificial shell, comprising:
(a) a top portion;
(b) a bottom portion; and
(c) a separate threaded portion to removably secure the top portion to the bottom portion;
(d) wherein the top and bottom portions, when secured together, jointly define a substantially egg-shaped structure having an inner chamber for containing food ingredients.

38. The artificial shell of claim 37, further comprising a fill opening.

39. The artificial shell of claim 38, further comprising a fill opening cover.

40. The artificial shell of claim 39, wherein the fill opening cover includes a grip portion.

41. The artificial shell of claim 37, further comprising a base.

42. The artificial shell of claim 37, wherein at least one of the top and bottom portions is comprised of food grade polypropylene plastic.

43. The artificial shell of claim 37, wherein at least one of the top and bottom portions is comprised of microwave safe material.

44. The artificial shell of claim 37, wherein at least one of the top and bottom portions is comprised of stainless steel.

45. The artificial shell of claim 37, wherein the inner chamber has a volume of approximately seventy milliliters.

46. The artificial shell of claim 37, wherein the inner chamber has a volume of approximately ninety milliliters.

47. The artificial shell of claim 37, wherein the inner chamber has a volume of approximately one hundred twenty milliliters.

48. The artificial shell of claim 37, wherein the inner chamber has a volume of approximately one hundred eighty milliliters.

49. A cooking system, comprising:
(a) top and bottom portions;
(b) a separate threaded portion to removably secure the top portion to the bottom portion, thereby defining an artificial shell; and
(c) food ingredients contained within the artificial shell.

50. The cooking system of claim 49, wherein the food ingredients include one or more eggs.

51. The cooking system of claim 49, wherein the food ingredients include fruit.

52. The cooking system of claim 49, wherein the food ingredients include spices.

53. The cooking system of claim 49, wherein the food ingredients include artificial flavoring.

54. The cooking system of claim 49, wherein the food ingredients include meat.

55. The cooking system of claim 49, wherein the food ingredients include poultry.

56. The cooking system of claim 49, wherein the food ingredients include fish.

57. The cooking system of claim 49, wherein the artificial shell includes a fill opening.

58. The cooking system of claim 49, wherein after cooking, the food ingredients have the same shape as the artificial shell.
